(19) United States
(12) Patent Application Publication
(10) Pub. No.: US 2020/0242306 A1
(43) Pub. Date: Jul. 30, 2020

(54) Legal document generating system and method

(71) Applicant: WEI-TE LIU, Taipei City (TW)

(72) Inventor: WEI-TE LIU, Taipei City (TW)

(21) Appl. No.: 16/744,563

(22) Filed: Jan. 16, 2020

(30) Foreign Application Priority Data
Jan. 25, 2019 (TW) 108102943

(51) Int. Cl. G06F 40/56; G06Q 50/18; G06F 40/186

(52) U.S. Cl. CPC G06F 40/56; G06F 40/186; G06Q 50/18

(57) ABSTRACT

Disclosed is a legal document generating system and method. The system includes a clause template database, a temporary database, a drafting module, and an output module. The drafting module receives a clause template index code to be drafted and an alterable clause content to be drafted and stores the alterable clause content in the temporary database according to the clause template index code. The output module fetches an unalterable clause content according to the clause template index code from the clause template database and fetches a corresponding alterable clause content from the temporary database, thereby outputting a legal document.

### CROSS REFERENCE TO RELATED APPLICATION

The present application claims the priority of Taiwanese Application No.

108102943, filed on Jan. 25, 2019.

### FIELD OF THE DISCLOSURE

The invention is related to a document generating system and method, and more particularly to a legal document generating system and method.

### BACKGROUND

According to the law, if all parties of a legal subject are unanimous on an issue, the legal effect will bind upon all parties regardless whether the unanimity is covert or overt. Hence, an oral contract is still deemed as an effective legal instrument. However, most people would like to put their mutual agreement into words to convert oral unanimity into a legal contract. Nevertheless, if the legal document is involved with property disposal, the legal document would be quite complex with structured legalese and would cite a lot of statutes and regulations. If a layperson who is not familiar with law and who does not know what should be written in a legal document writes a legal document, the written legal document would be biased in favor of one party and bring harm to the other party of the legal document, which would result in long-lasting hassles.

Although it is possible to retain a lawyer to draft a legal document, the cost of hiring a lawyer would be quite expensive. Besides, if the legal issue at dispute concerns the scandal of a family or a clan, both parties of the legal issue at dispute will be quite reluctant to divulge their scandalous secret to their lawyer.

There is a tendency to develop a legal document generating system and method to address the problems encountered by the prior art.

### SUMMARY

To overcome the problems existed in the prior art, the invention is aimed to provide a legal document generating system and method, which includes a clause template database, a temporary database, a drafting module, and an output module. The drafting module is set to receive a clause template index code and the alterable clause content to be drafted and store the alterable clause content in the temporary database according to the clause template index code. The output module is set to fetch the corresponding unalterable clause content from the clause template database according to the clause template index code and fetch the corresponding alterable clause content from the temporary database, thereby outputting a legal document. The legal document is an instrument that is legally meaningful and can become legally effective by signing on it.

The legal document generating system and method can assist those who are not familiar with legal statute to write an effective legal document on their own through guidance.

### BRIEF DESCRIPTION OF THE DRAWINGS

To illustrate the technological scheme embodying the embodiment of the invention more clearly, the accompanying drawings showing the embodiment of the invention or the conventional technology will be briefed in the following. Apparently, the accompanying drawings stated below are merely affiliated to some embodiments of the invention. An artisan having ordinary skill in the art can devise other drawings based on the accompanying drawings without exerting non-inventive laboring. In the figures:

FIG. 1 is a systematic block diagram showing a concrete embodiment of a legal document generating system according to the invention;

FIG. 2 is a flow chart illustrating the legal document generating method according to the invention;

FIG. 3 is a schematic diagram showing the clause template data according to the invention;

FIG. 4 is a schematic diagram showing the generated legal document according to the invention;

FIGS. 5A-5C are schematic diagrams showing the application of a divorce agreement generator according to the invention; and

FIGS. 6A-6C are schematic diagrams showing the application of a will generator according to the invention.

### DETAILED DESCRIPTION OF PREFERRED EMBODIMENTS

Next, the invention will be elaborated clearly and exhaustively with reference to the accompanying drawings. Apparently, the embodiments described herein are merely taken as being illustrative in nature but not limiting to the scope of the disclosure. Based on the embodiments disclosed herein, any embodiments derived by an artisan skilled in the art without inventive laboring should be encompassed in the scope of the disclosure.

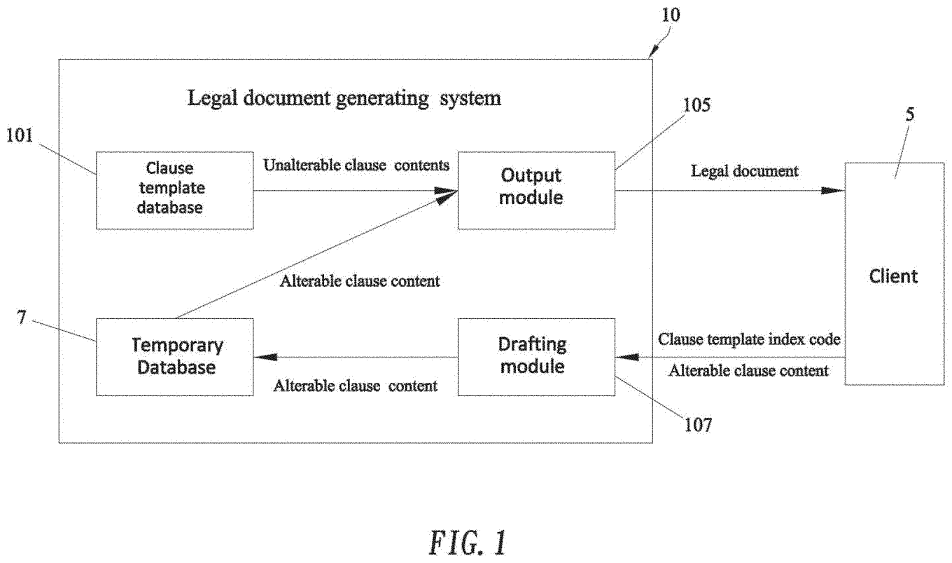

Firstly, as shown in FIG. 1, a legal document generating system 10 according to the invention is built in a client. The legal document generating system 10 includes a clause template database 101, a temporary database 7, a drafting module 107, and an output module 105.

The clause template database 101 is used to store a plurality of clause template data, each of which includes a clause template index code and an unalterable clause content corresponding to the clause template index code.

The temporary database 7 is used to store a plurality of temporary data, each of which includes a temporary index code and the clause template index code corresponding to the temporary index code, and an alterable clause content corresponding to the clause template index code.

The drafting module 107 is coupled to the clause template database 101 and the temporary database 7 and is configured to receive the clause template index code and the alterable clause content to be drafted, and temporarily store the alterable clause content in the temporary database 7 according to the clause template index code.

The output module 105 is coupled to the temporary database 7 and the clause template database 101 and is configured to fetch a corresponding unalterable clause content from the clause template database according to the clause template index code, and fetch a corresponding alterable clause content from the temporary database 7, thereby outputting a legal document. The legal document includes at least one statute, each of which includes the unalterable clause content and the alterable clause content. The alterable clause content in the legal document is disallowed to be blank.

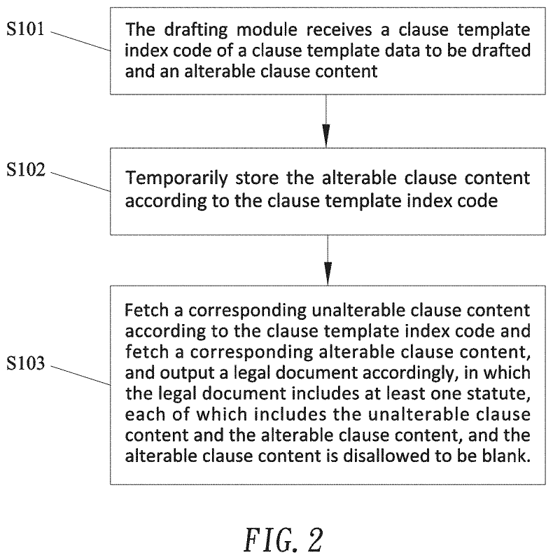

As shown in FIG. 1 and FIG. 2, the execution of the legal document generating system 10 is illustrated below with reference to FIG. 2. FIG. 2 is a flow chart illustrating the legal document generating method according to the invention.

In step S101, the drafting module 107 receives a clause template index code of a clause template data and an alterable clause content to be drafted.

In step S102, the alterable clause content is temporarily stored according to the clause template index code.

In step S103, a corresponding unalterable clause content is fetched according to the clause template index code and a corresponding alterable clause content is fetched, and thereby outputting a legal document. The legal document includes at least one statute, each of which includes the unalterable clause content and the alterable clause content. The alterable clause content in the legal document is disallowed to be blank.

Preferably, the output module 105 includes a display, a printer, and a network transmission device. That is, the legal document generated through the output module 105 can be displayed on a display, or printed through a printer, or transmitted to other information receiving apparatus through a network transmission device. The output module 105 includes hardware components and allows hardware and the software to work coherently.

Preferably, the client 5 can conduct data transmission bi-directionally with the legal document generating system 10 through Internet. Concretely speaking, the legal document generating system 10 transmits the screen to be displayed to the client for display. The information to be inputted and displayed on screen are received first and then transmitted to related module. The client 5 may be a desktop computer, a laptop computer, a tablet computer, or a smartphone. The legal document generating system 10 can be integrated with the client 5. That is, the client can merely include the hardware components (e.g., a smartphone) required to execute the legal document generating system 10. Certainly, the legal document generating system 10 and the client may be configured in a client/server architecture.

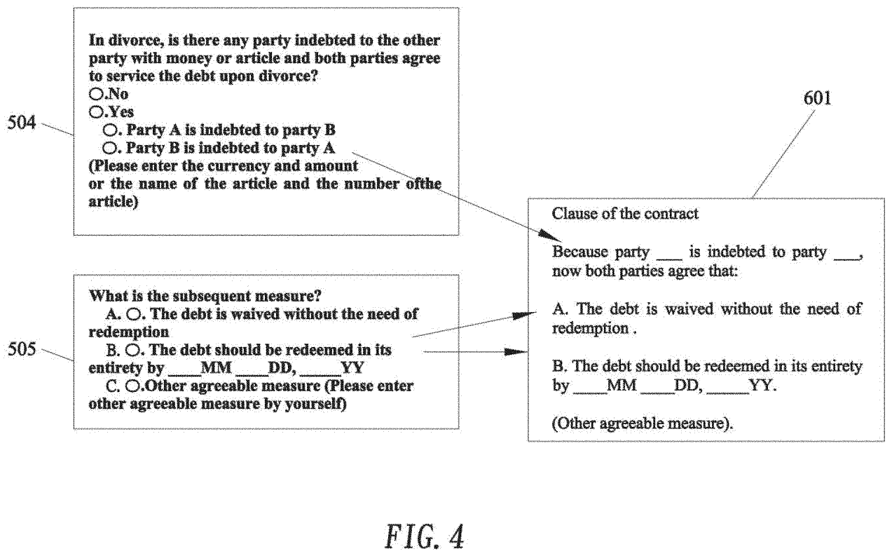

The statute 601 in the legal document (as shown in FIG. 4) outputted by the legal document generating system 10 of the invention includes the unalterable clause content from the clause template database 101 and the alterable clause content from the temporary database 7. However, the alterable clause content is disallowed to be blank. Next, the method of compiling and outputting the legal document is described in the following.

Simply speaking, when the user wants to create a new legal document, the system will ask the user to input information about person, business, date/time, place, and article. For example, if the legal document is a will, the user should input the information of testator, date of the will, the name of inheritor, and property inventory if property distribution is desired. Next, the system will help the user to create a legal document in an interactive and guiding e way. That is, the system will interact with the user in a tentative way with instructions and selections. The user only needs to concretely fill out the facts and requirements. In this way, a lay person does not need to worry about what to write in a legal document and how to write a legal document anymore. With the guidance and help of the legal document generating system of the invention, the user can smoothly write an effective and complete legal document.

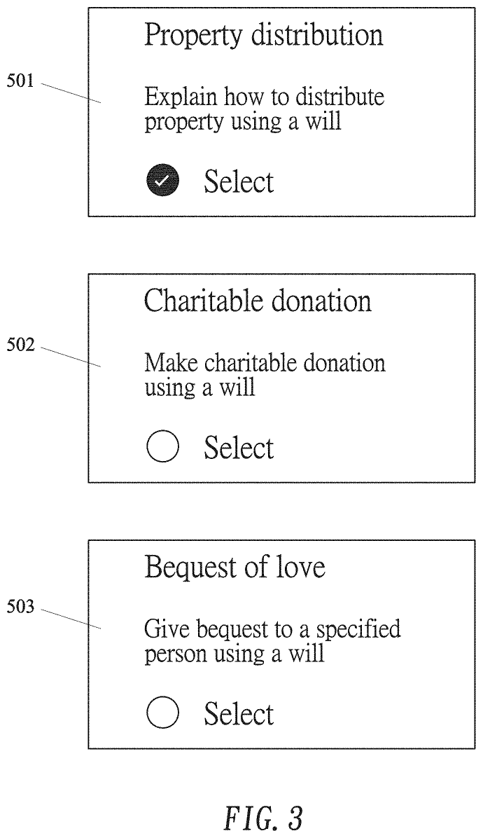

FIG. 3 is a schematic diagram showing an example of the clause template data. In FIG. 3, a plurality of clause template data 501-503 are stored in the clause template database 101. The clause template data 501-503 are displayed on the client 5 for being selected by the user. The clause template data which is selected is indicated by a symbolic sign, such as a check sign, in order to remind the user which of the clause template data are selected. Hence, when the user selects the clause to be drafted in the legal document from the clause template data 501-503 in FIG. 3, the drafting module 107 receives the clause template index code corresponding to the selected clause template data to be drafted. In the clause template data 501-503, in order to facilitate the user to select the desired clause template data, each clause template data includes a brief explanation with a word count of around 10 appended to the title of the clause template data. When the user is filling in the clause template with facts and requirements, further detailed explanation will be displayed. This is to avoid the user from getting shocked as he/she receives a plethora of information in the beginning. Thus, the invention is configured to display detailed information when necessary.

For different clause template data 501-503, different blanks are required for the user to fill in with facts and requirements. However, in order to lower the complexity of the legal document generation, the alterable clause content may be built by way of making selection by a selective menu or a pull-down menu, or by filling blanks.

FIG. 4 is a schematic diagram showing the generated legal document according to the invention. In FIG. 4, the user is filling in the selected clause template data with facts and requirements by way of a selective menu.

For example, the clause template data 504 is “In divorce, is there any party indebted to the other party with money or article and both parties agree to service the debt upon divorce?”. The selective menu corresponding to this data includes the selection items of “Yes” and “No”. If the user selects “Yes”, two selection items “The party A is indebted to party B” and “The party B is indebted to party A” will be further displayed for user to select. Further, the user will be asked to fill in the currency and amount of the debt, or the name and number of the article of the debt. If the user selects “No”, the user will not be asked to fill in anything. After all the selections are made and all required information are filled in through guidance, the alterable clause content 601 in the legal document is completed. The user does not need to worry about how to write the alterable clause content.

Anyhow, the drafting module 107 will store the alterable clause content received according to the clause template index code in the temporary database 107. The user still needs to make selection and fill in the blanks for different clause template data 501-505. When the required clause template data are all filled in, the alterable clause content can be fetched from the temporary database 7 according to the clause template index code, such that the user can complete each clause 601 in the legal document.

In this way, after all of the clauses are completed, the user input instructions to enable the output module 105 to fetch unalterable clause content corresponding to the clause template index code from the clause template database 101, and fetch corresponding alterable clause content from the temporary database 7, thereby outputting a legal document. For example, in the clause “Because party is indebted to party,” the part of the underscore in this clause is classified as alterable clause content, while other parts of this clause is classified as unalterable clause content. If the user selects “Party A is indebted to party B” from the item table 504, this clause will become “Because party A is indebted to party B, now both parties agree that:”.

Each clause template data may have a plurality of aspects. The unalterable clause content indexed by the clause template index code may have different versions according to the aspects. For example, the clause template data 501 is “What is the subsequent measure?”. Two different versions of unalterable clause content are available for this clause template data 501. The first version is “A. The debt is waived without the need of redemption.”. The second version is “B. The debt should be redeemed in its entirety by ______ MM ______ DD, ______ YY.”

Besides, although the sequence of the clauses is arranged in accordance with the common practice, the system still allows the user to adapt the sequence of the clauses. Hence, when the clause template data corresponding to the clause template index code and received by the drafting module is a multi-item clause, the legal document includes a plurality of corresponding statutes, and the sequence of the plurality of corresponding statutes in the legal document outputted from the output module is adaptable.

Preferably, the legal document generating system 10 is implemented as a legal document generator APP which is installable in a smartphone. The legal document generator APP can create a legal document, which at least includes a settlement, an agreement, a deposit letter, a lease/rental contract, or a sales/purchase contract.

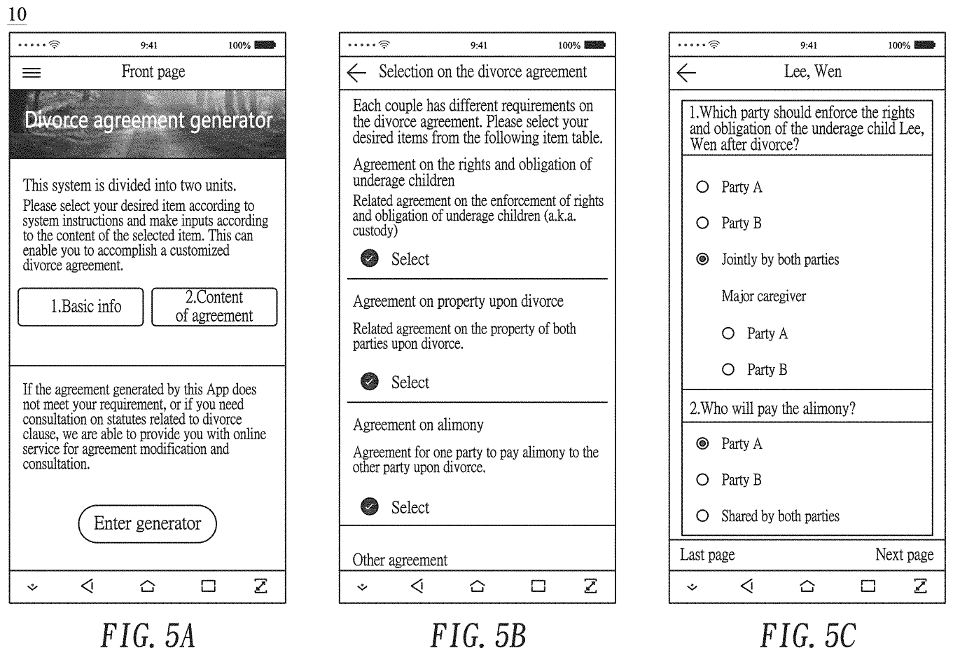

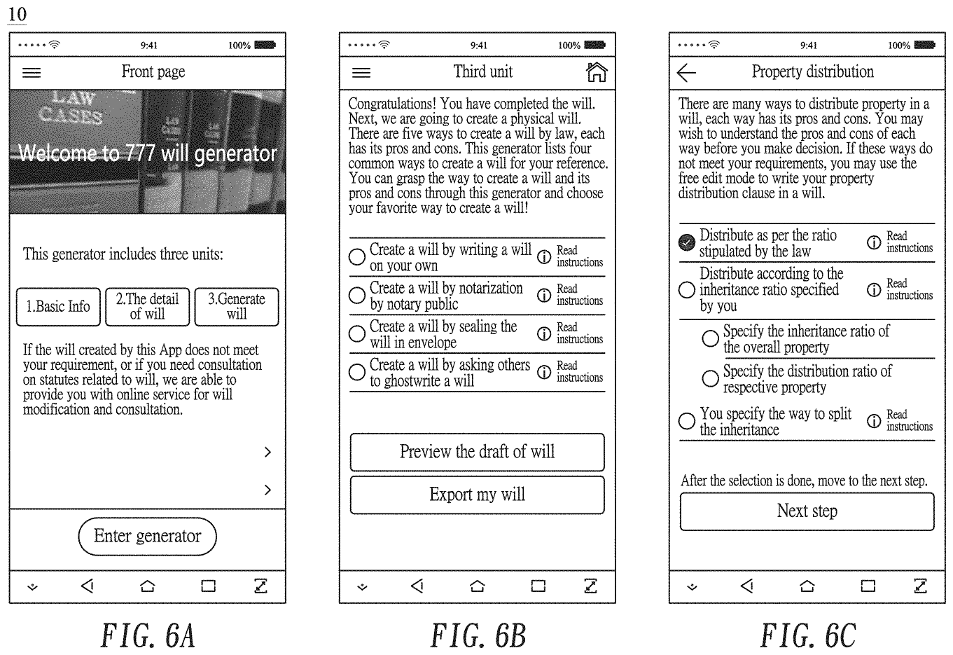

Preferably, the legal document further at least includes, but is not limited to, a divorce agreement, a will, an estate tax application form, or a land registration application form. For example, FIGS. 5A to 5C show the application of a divorce agreement generator APP according to the invention, and FIGS. 6A to 6C show the application of a will generator APP according to the invention. The operation of these APPs is not intended to be detailed herein.

The above descriptions only disclose a preferred embodiment of the invention. However, it is to be understood that the invention should not be limited to the accurate form or the preferred embodiments disclosed herein. The preferred embodiments stated above can not be taken to limit the scope of the invention. The invention should encompass various modifications and alterations made based on the foregoing embodiments. An artisan having ordinary skill in the art can understand the way to embody the foregoing embodiment, and the equivalent modifications which are made based on the claims are still within the scope of the invention.

What is claimed is:

1. A legal document generating system, comprising:
a clause template database storing a plurality of clause template data, each of which includes a clause template index code and an unalterable clause content indexed by the clause template index code;
a temporary database storing a plurality of temporary data, each of which includes a temporary index code, a clause template index code corresponding to the temporary index code, and an alterable clause content;
a drafting module coupled to the clause template database and the temporary database and configured to receive a clause template index code to be drafted and an alterable clause content indexed by the clause template index code, and temporarily store the alterable clause content indexed by the clause template index in the temporary database in accordance with the clause template index code; and
an output module coupled to the temporary database and the clause template database and configured to fetch an unalterable clause content from the clause template database according to the clause template index code and fetch an alterable clause content from the temporary database, and in response thereto output a legal document;
wherein the legal document includes at least one clause, each of which includes an unalterable clause content and an alterable clause content; and
wherein the alterable clause content is disallowed to be blank.

2. The legal document generating system according to claim 1 wherein:
if the clause template data corresponding to the clause template index code and received by the drafting module is a multi-item clause, the legal document includes a plurality of corresponding statutes, and the sequence of the plurality of corresponding statutes in the legal document outputted from the output module is adaptable.

3. The legal document generating system according to claim 1 wherein:
if the clause template data corresponding to the clause template index code and received by the drafting module is a multi-item clause, the legal document includes a plurality of corresponding statutes, and the output module fetches the unalterable clause content according to the clause template index code from the clause template database and fetches the alterable clause content from the temporary database accordingly, thereby outputting the legal document.

4. The legal document generating system according to claim 1 wherein the alterable clause content received by the drafting module is established by conducting fill-in-the-blank operations or by making selection by a selective menu or a pull-down menu.

5. The legal document generating system according to claim 1 wherein each clause template data has a plurality of aspects, and the unalterable clause content indexed by the clause template index code has different versions according to the aspect of the clause template data.

6. The legal document generating system according to claim 1 wherein the client is configured to conduct data transfer bi-directionally with the legal document generating system through an Internet, and wherein the client includes a desktop computer, a laptop computer, or a tablet computer.

7. The legal document generating system according to claim 6 wherein the legal document generating system is an application of legal document generator installed in a smartphone, and wherein the legal document at least includes a settlement, a deposit letter, a lease/rental contract, or a sales/purchase contract.

8. The legal document generating system according to claim 6 wherein the legal document generating system is an application of legal document generator installed in a smartphone, and wherein the legal document at least includes a divorce agreement, a will, an estate tax application form, or a land registration application form.

9. A method for generating a legal document, comprising:
providing a clause template database storing a plurality of clause template data, each of which includes a clause template index code and an unalterable clause content indexed by the clause template index code;
providing a temporary database storing a plurality of temporary data, each of which includes a temporary index code, a clause template index code corresponding to the temporary index code, and an alterable clause content;
receiving a clause template index code of a clause template data from the clause template database and an alterable clause content to be drafted from the temporary database;
temporarily storing the alterable clause content according to the clause template index code;
fetching a corresponding unalterable clause content according to the clause template index code and fetching a corresponding alterable clause content; and
outputting a legal document including at least one statute, each of which includes the unalterable clause content and the alterable clause content, wherein the alterable clause content is disallowed to be blank.
